(19) United States
(12) Patent Application Publication
(10) Pub. No.: US 2024/0256233 A1
(43) Pub. Date: Aug. 1, 2024

(54) Generating Previews of Entity Assets

(71) Applicant: Salesforce, Inc., San Francisco, CA (US)

(72) Inventors: Anagha Pande, Los Gatos, CA (US); Cristobal Vergara Niedermayr, Smyrna, GA (US)

(73) Assignee: Salesforce, Inc., San Francisco, CA (US)

(21) Appl. No.: 18/104,126

(22) Filed: Jan. 31, 2023

(51) Int. Cl. G06F 8/38; G06F 9/451

(52) U.S. Cl. CPC G06F 8/38; G06F 9/451; G06F 3/0482

(57) ABSTRACT

A user device may modify structure information for a user interface (UI) to display the content by allocating a portion of the UI to a preview element for an asset associated with the content based on a request for content related to an entity. The user device may retrieve a code library with functions for manipulating assets of the entity from a static resource for the user interface based on the modified structure information. The user device may generate the UI comprising a preview of the asset within a portion of the UI based on image data indicative of the asset received via a function of the code library and mapped to the preview element.

### BACKGROUND

Content management systems (CMS), for example, user interfaces and/or the like provided by a CMS are often used to manage websites and other digital platforms and can be used to store and organize text, images, videos, and other types of content. Entities (e.g., businesses, customer relationship management (CRM) platforms, service providers, etc.), for various reasons (e.g., security, cost, technical/technology-related issues, etc.) often lack a built-in CMS, and instead integrate with a third-party CMS to manage content. User interfaces and/or the like often use thumbnails to provide a preview of the content managed by a CMS and/or the like. However, a CMS is routinely unable to provide thumbnails for the content provided by and/or associated with an entity without incorporating a large suite of application programming interfaces (APIs) and/or user interface (UI) components. Incorporating large suites of APIs and/or UI components is cumbersome, error-prone, and insecure—often resulting in wasted computing resources, failed system integrations, and/or unauthorized access to sensitive data. Further, the inability of a user interface and/or the like to generate thumbnails and/or previews of content provided by and/or associated with an entity negatively affects the usability of the user interface and/or the like.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 shows an example system for generating previews of entity assets, according to some aspects of this disclosure.

FIG. 2A-2B show an example user interface, according to some aspects of this disclosure.

FIG. 3 shows a flowchart of an example method for generating previews of entity assets, according to some aspects of this disclosure.

FIG. 4 shows a schematic block diagram of an example computer system in which aspects described may be implemented.

### DETAILED DESCRIPTION

Provided herein are system, apparatus, device, method, computer program product embodiments, and/or combinations and sub-combinations thereof, for generating previews of entity assets. A user device (e.g., a client-side device, a computing device, a smart device, a mobile device, a laptop, a tablet, a display device, etc.) may receive structure information for a user interface to display content related to an entity based on an identifier of the entity included with a request for the content. Based on the content, the user device may modify the structure information to allocate a portion of the user interface to a preview element for an asset associated with the content. The user device may retrieve a code library with functions for manipulating assets of the entity based on the modified structure information and from a static resource for the user interface. The user device may receive image data indicative of the asset based on a function of the code library. The user device may generate and/or display the user interface based on the image data mapped to the preview element. The portion of the user interface may include a preview of the asset.

In other words, according to some aspects of this disclosure, a code (e.g., JavaScript, Python, Ruby, Pearl, Dart, etc.) library that securely generates previews (e.g., thumbnails, representation windows, etc.) of entity-related content. According to some aspects of this disclosure, secure functionality is built into the code library and the code library provides functions and/or ways to disallow unsafe actions and/or communications (e.g., communications between a client device and server, etc.), for example, unsafe HTML methods (e.g., PUT, DELETE, etc.). According to some aspects of this disclosure, utilizing the code library, the system, apparatus, device, method, computer program product embodiments, and/or combinations and sub-combinations thereof, for generating previews of entity assets provides a direct way to generate previews of entity-related assets within an entity-managed user interface framework in response to a request from a user device (e.g., a client device, a mobile device, a smart device, etc.) with minimal or no communication between its controllers and a server (and/or the like). According to some aspects of this disclosure, the system, apparatus, device, method, computer program product embodiments, and/or combinations and sub-combinations thereof, for generating previews of entity assets, through the use of the code library integrated with a client device supports a rich set of attributes that enable animated/dynamic previews of assets, user interface styling (e.g., content styling, interactive frame styling, etc.), and/or the like. According to some aspects of this disclosure, the system, apparatus, device, method, computer program product embodiments, and/or combinations and sub-combinations thereof, for generating previews of entity assets provides a quicker, more efficient, and richer way to generate previews for entity-related assets and support interaction with entity-related assets via actions included, but not limited to, hover-over, click-through, and/or the like. These and other technological advantages are described herein.

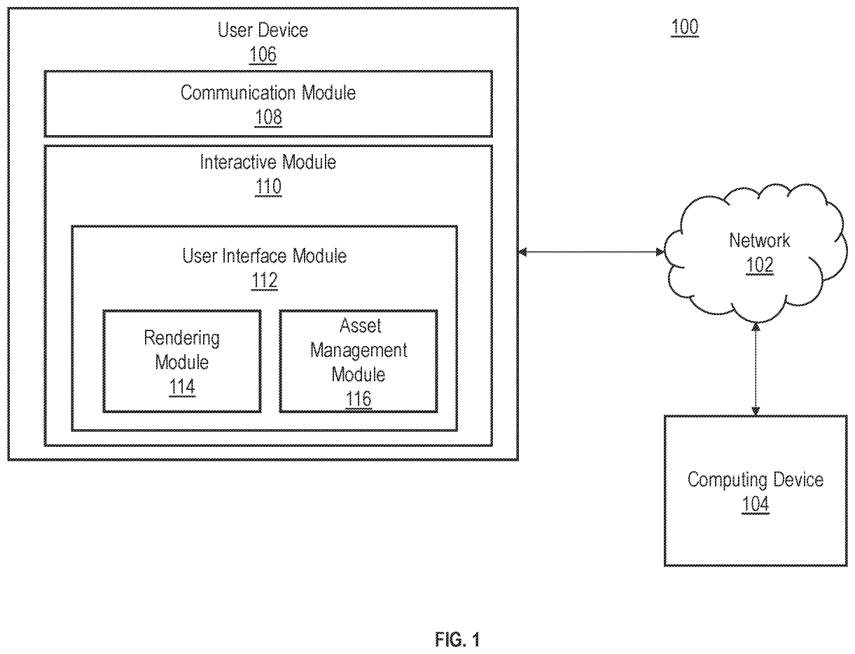

FIG. 1 shows an example system 100 for generating previews of entity assets. According to some aspects of this disclosure, the loading of a page may include, but is not limited to, presenting/displaying a user interface page, a file download, a data transfer, and/or the like. According to some aspects of this disclosure, system 100 is merely an example of one suitable system environment and is not intended to suggest any limitation as to the scope of use or functionality of aspects described herein. Neither should the system 100 be interpreted as having any dependency or requirement related to any single module/component or combination of modules/components described therein.

According to some aspects of this disclosure, system 100 may include a network 102. According to some aspects of this disclosure, network 102 may include a packet-switched network (e.g., internet protocol-based network), a non-packet-switched network (e.g., quadrature amplitude modulation-based network), and/or the like. According to some aspects of this disclosure, network 102 may include network adapters, switches, routers, modems, and the like connected through wireless links (e.g., radiofrequency, satellite) and/or physical links (e.g., fiber optic cable, coaxial cable, Ethernet cable, or a combination thereof). According to some aspects of this disclosure, network 102 may include public networks, private networks, wide area networks (e.g., Internet), local area networks, and/or the like. According to some aspects of this disclosure, network may include a content access network, content distribution network, and/or the like. According to some aspects of this disclosure, network 102 may provide and/or support communication from telephone, cellular, modem, and/or other electronic devices to and throughout system 100. For example, system 100 may include a user device 106 in communication with a computing device 104 via network 102.

According to some aspects of this disclosure, computing device 104 may include a server (e.g., a web server, an application server, an entity-owned and/or operated server, an identity management device, etc.), and/or the like.

According to some aspects of this disclosure, computing device 104 may support any applications, and/or functions including, but not limited to, applications and/or functions enabled and/or supported by, but not limited to, Hypertext Transfer Protocol (HTTP) HTTP servers, File Transfer Protocol (FTP) servers, Common Gateway Interface (CGI) servers, data servers, Java servers, business/entity application servers, and/or the like. According to some aspects of this disclosure, computing device 104 may execute programs and/or scripts in response to requests from user device 106, such as by executing one or more Web applications that can be implemented as one or more scripts or programs written in any programming and/or scripting language including, but not limited to, Java®, C, C#, C++, Perl, Python, TCL, combinations thereof, and/or the like. Although shown as a single device, according to some aspects of this disclosure, computing device 104 may include a plurality of computing devices (e.g., servers, network devices, etc.), support/include an integrated system/platform for providing content, and/or the like.

According to some aspects of this disclosure, computing device 104 may be part of and/or include a system and/or software platform, including, but not limited to an integration platform, a customer relationship management (CRM) platform, and/or the like configured to access and/or provide a plurality of software applications, services, and/or the like. According to some aspects of this disclosure, computing device 104 be configured to design, maintain, and deploy marketing campaigns, integration flows, and/or the like based on disparate software applications, services, and/or the like. For example, computing device 104 may include/incorporate an enterprise service bus (ESB) architecture, a micro-service architecture, a service-oriented architecture (SOA), and/or the like. According to some embodiments, computing device 104 may enable a user to build and deploy integrations that communicate with and/or connect to third-party systems and provide additional functionalities that may be used to further integrate data from a plurality of organizational and/or cloud-based data sources. According to some embodiments, computing device 104 may enable users to build campaigns, integration flows, and/or APIs, and to design integration applications that access data, manipulate data, store data, and leverage data from disparate technical resources.

According to some embodiments, computing device 104 may include and/or be part of an identity management system for an entity. According to some embodiments, computing device 104 may verify the identity of a user and/or user device (e.g., user device 106, etc.). For example, computing device 104 may verify credentials of a user and/or user device including, but not limited to, a username, a password, biometric information, multi-factor authentication information, single sign-on (SSO) information, information used for identity federation, and/or the like. According to some embodiments, computing device 104 may authorize and/or deny a user and/or user device to access assets, content, resources, and/or the like. According to some embodiments, computing device 104 may generate and/or maintain user and/or user device identities and their associated access privileges. According to some embodiments, computing device 104 may generate new user accounts, update existing accounts, and/or disable/delete accounts as needed. According to some embodiments, computing device 104 may facilitate directory services and/or operate as a centralized repository of user and/or user device identities, which can be used to authenticate and authorize users and/or user devices across different systems and applications.

According to some embodiments, computing device 104 may generate, utilize, access, and/or store a plurality of assets (e.g., files, content items, emails, landing pages, forms, etc.). According to some embodiments, assets (e.g., files, content items, emails, landing pages, forms, etc.) may be part of, associated with, generated by, in accordance with, and/or the like standard objects (e.g., accounts, contacts, opportunities, leads, reporting tools/APIs, automation tools/APIs, data management tools/APIs, etc.), features, functionality, and/or the like included with and/or provided by computing device 104. According to some embodiments, computing device 104 may use assets to manage a wide range of business processes including, but not limited to, sales, marketing, customer service, and/or the like.

According to some aspects of this disclosure, assets from and/or supported by computing device 104 may be accessed by a content browser, for example, such as a user interface module 112 of the interactive module 110, and/or the like. According to some aspects of this disclosure, previews of assets of computing device 104 may be accessed, viewed, displayed, and/or the like via preview windows, representation elements, and/or thumbnails generated, accessible, interfaced, and/or the like by user device 106 (e.g., asset management module 116, etc.).

According to some aspects of this disclosure, user device 106 may include a client device, a computing device, a smart device, a mobile device, a laptop, a tablet, a display device, or any other device capable of communicating with computing device 104. The user device 106 may include a communication module 108 that facilitates and/or enables communication with computing device 104 and/or any other device/component of the system 100. For example, communication module 108 may include hardware and/or software to facilitate communication. The communication module 108 may comprise one or more of a modem, transceiver (e.g., wireless transceiver, etc.), digital-to-analog converter, analog-to-digital converter, encoder, decoder, modulator, demodulator, tuner (e.g., QAM tuner, QPSK tuner), and/or the like. The communication module 108 may include any hardware and/or software necessary to facilitate communication.

According to some aspects of this disclosure, user device 106 may include an interactive module 110. According to some aspects of this disclosure, interactive module 110 enables a user to interact with user device 106, computing device 104, and/or the like. According to some aspects of this disclosure, interactive module 110 may include one or more input devices and/or components, for example, such as a keyboard, a pointing device (e.g., a computer mouse, remote control), a microphone, a joystick, a tactile input device (e.g., touch screen, gloves, etc.), and/or the like. According to some aspects of this disclosure, interaction with the input devices, and/or components may enable a user to view, visit, access, request, and/or navigate to a user interface generated and/or displayed by a user interface module 112. According to some aspects of this disclosure, interactive module 110 may include any interface for presenting and/or receiving information to/from a user.

According to some aspects of this disclosure, interactive module 110 may include the user interface module 112. According to some aspects of this disclosure, user interface module 112 may be, include, and/or communicate with an interactive module for generating and/or enabling access to a user interface. According to some aspects of this disclosure, user interface module 112 enables a user to build a user interface and/or web components that run on computing device 104 (e.g., an interactive platform provided by and/or in communication with computing device 104, etc.). According to some aspects of this disclosure, user interface module 112 may support user interface and/or web development technologies including, but not limited to, JavaScript, Web Components, and/or the like. According to some aspects of this disclosure, user interface module 112 enables users to customize the design and/or operation of a user interface, add functionality, and integrate with any device/component of system 100 and/or other systems.

According to some aspects of this disclosure, user interface module 112 enables a user to view previews of assets of computing device 104. According to some aspects of this disclosure, user interface module 112 may be used to access and/or generate a user interface that includes previews (e.g., thumbnails, interactive representations, etc.) of assets of computing device 104.

According to some aspects of this disclosure, user interface module 112 may include a web browser (e.g., Internet Explorer®, Mozilla Firefox®, Google Chrome®, Safari®, or the like). The user interface module 112 may request or query various files from a local source (e.g., a code library, etc.) and/or a remote source, such as the computing device 104, and/or the like.

According to some aspects of this disclosure, interactive module 110 may include a rendering module 114. According to some aspects of this disclosure, rendering module 114 may generate, render, and/or display a user interface (e.g., a web page, application page, documentation, a screen, etc.). According to some aspects of this disclosure, rendering module 114 may use information indicating a structure of a page, screen, and/or the like of a user interface to generate, render, and/or cause to be displayed the page, screen, and/or the like. According to some aspects of this disclosure, a structure of a page, screen, and/or the like of a user interface may indicate an arrangement of elements (e.g., previews of assets, data/information fields, logos, icons, analytical elements, interactive tools, data/information links/references, regions, images, content, paragraphs, etc.) of the page, screen, and/or the like. For example, according to some aspects of this disclosure, rendering module 114 may use document object models (DOMs), cascading style sheets object models (CSSOMs), hypertext markup language (HTML) elements, and/or the like to generate, render, and/or cause to be displayed a page, screen, and/or the like of a user interface.

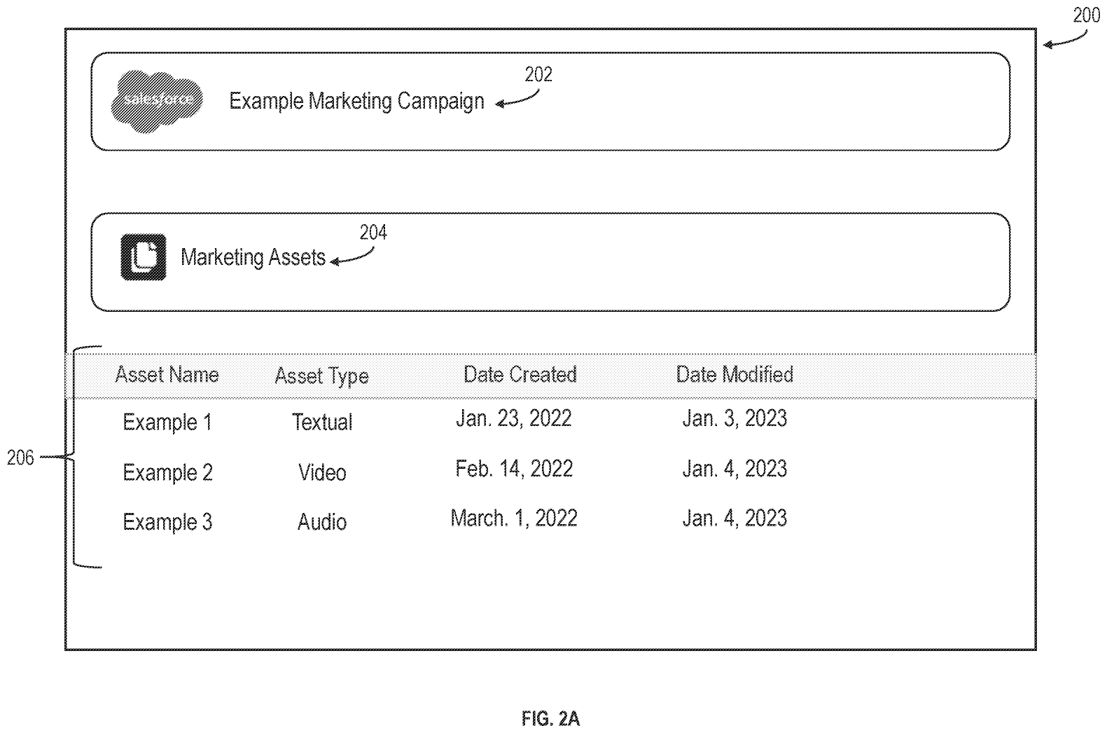

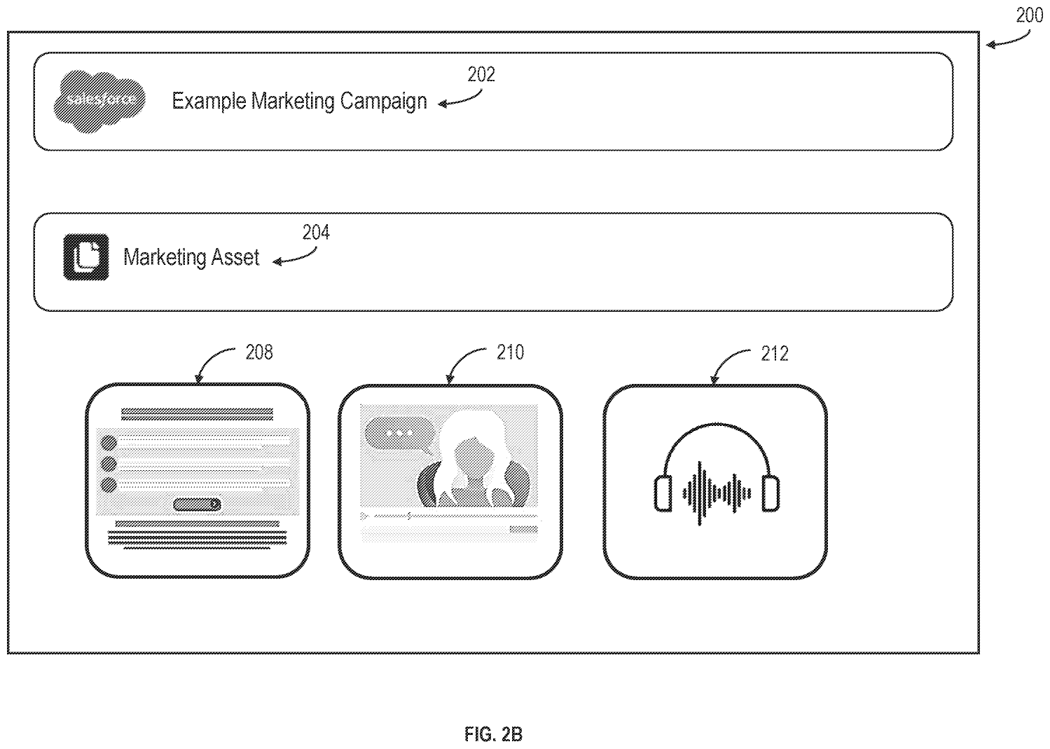

FIG. 2A shows an example user interface 200 generated (e.g., via rendering module 114, etc.) and/or displayed by user device 106. According to some aspects of this disclosure, user interface 200 may be generated responsive for a request for content associated with an entity domain. For example, user device 106 may request content 202 and/or information related to content 202. In this example, content 202 may include information/data for and/or associated with a marketing campaign. According to some aspects of this disclosure, user interface 200 may be generated responsive for a request for any type of content associated with an entity domain and/or the like.

According to some aspects of this disclosure, user interface 200 may include an indication 204 of assets associated with the requested content that may be accessible via user interface 200. According to some aspects of this disclosure, user interface 200 may include asset information 206 that provides a description of assets associated with the requested content that may be accessible via user interface 200 and indicated by indication 204. According to some aspects, asset information 206 may indicate a respective name, asset type, creation date (e.g., when an asset is added and/or generated within the entity domain, etc.), modification date (e.g., when an asset is changed, updated, and/or modified within the entity domain, etc.), and/or the like for each asset associated with content within the entity domain.

Returning to FIG. 1, according to some aspects of this disclosure, interactive module 110 may include an asset management module 116. According to some aspects of this disclosure, asset management module 116 may generate, render, and/or cause to be displayed previews (e.g., thumbnails, interactive representations, etc.) of assets of computing device 104. According to some aspects of this disclosure, a preview may represent how an asset of computing device 104 will appear to a user once loaded, accessed, and/or the like. According to some aspects of this disclosure, the preview may be animated and/or dynamic, for example, representations of portions of an asset may be manipulated (e.g., scrolled, zoomed, size changed, etc.), modified, and/or the like, to display portions of the asset.

According to some aspects of this disclosure, asset management module 116 may include a code library that facilitates the secure generation of previews of entity assets and//or entity-related content. According to some aspects of this disclosure, the code library may be configured to support multiple file types including, but not limited to, JPEG, PNG, GIF, MOV, MPEG, and/or the like. According to some aspects of this disclosure, secure functionality is built into the code library and the code library provides functions and/or ways to disallow unsafe actions and/or communications (e.g., communications between user device 106 and computing device 104, etc.) including, but not limited to, unsafe HTML methods (e.g., PUT, DELETE, etc.).

According to some aspects of this disclosure, asset management module 116, utilizing the code library to generate previews of entity assets is a direct way for asset management module 116 to generate previews of entity-related assets (e.g., assets of computing device 104, etc.) in response to a request from user device 106 with minimal or no communication between its controllers and computing device 104. According to some aspects of this disclosure, the code library is configured to support a rich set of attributes that enable animated/dynamic previews of assets, user interface styling (e.g., content styling, interactive frame styling, etc.), and/or the like. According to some aspects of this disclosure, the code library enables asset management module 116 to generate previews of entity assets and provides a quick, efficient, and richer way to generate previews for entity-related assets and support interaction with entity-related assets via actions included, but not limited to, hover-over, click-through, and/or the like.

FIG. 2B shows the example user interface 200 of FIG. 2A generated (e.g., via rendering module 114, etc.) and/or displayed by user device 106. According to some aspects of this disclosure, structure information (e.g., DOM tree, etc.) for user interface 200 may be modified to include preview elements (e.g., iframes, etc.) that enable previews of assets (e.g., indicated by an indication 204, etc.) to be displayed via user interface 200.

According to some aspects of this disclosure, preview 208 provides a preview of an entity asset named Example 1 (e.g., see asset information 206 of FIG. 2A), preview 210 provides a preview of an entity asset named Example 2 (e.g., see asset information 206 of FIG. 2A), preview 212 provides a preview of an entity asset named Example 3 (e.g., see asset information 206 of FIG. 2A). According to some aspects of this disclosure, preview 208 may be a preview of a textual asset and may indicate the most important and/or relevant text of the asset named Example 1. According to some aspects of this disclosure, preview 210 may be a preview of a video asset and may indicate the most important and/or relevant images and/or video sections (e.g., frames, portions, etc.) of the asset named Example 2. According to some aspects of this disclosure, preview 212 may be a preview of an audio asset and may indicate the most important and/or relevant audio content of the asset named Example 3. According to some aspects of this disclosure, interaction (e.g., hover-over, click-through, selection, etc.) of previews 208-212 enables access to the respective assets.

Returning to FIG. 1, according to some aspects of this disclosure, to generate previews for assets, asset management module 116 may store a code library with functions for generating previews for assets as a static web resource and/or the like. For example, according to some aspects of this disclosure, asset management module 116 may store the code library as a static web resource to facilitate adding custom JavaScript logic to a user interface, styling visual elements of the user interface, and/or adding images or other multimedia content to the user interface. According to some aspects of this disclosure, asset management module 116 may reference the code library by using a resource indicator including, but not limited to, a URL of the code library. According to some aspects, for security asset management module 116 may generate, render, and/or cause to be displayed a preview of an entity-related asset via a server-less function of the code library.

According to some aspects, asset management module 116 may generate, render, and/or cause to be displayed a preview of an asset by using a just-in-time compiled programming language such as JavaScript, Typescript, Dart, ClojureScript, Ruby, Python, and/or the like. For example, JavaScript with dynamic generation of a Document Object Model (DOM) and Cascading Style Sheets (CSS) may be used to generate, render, and/or cause the display of previews of entity-related assets. According to some aspects, user device 106 may use and/or implement any programming language to generate, render, and/or cause the display of a preview page for a page of a user interface. According to some aspects of this disclosure, asset management module 116 may generate previews of assets by processing each preview shown with a user interface asynchronously in JavaScript and/or the like, staging the previews after creation, and then updating the DOM for a user interface all at once.

According to some aspects, asset management module 116 may receive information indicative of a DOM for a user interface from the computing device 104, an entity-managed device (e.g., an entity-managed cloud-based server, etc.), a third-party source, and/or the like. According to some aspects of this disclosure, the DOM may be stored as a base64 image (e.g., using canvas element, JavaScript, etc.). According to some aspects of this disclosure, the DOM may be stored locally, via a storage module/component of user device 106 and/or the like. According to some aspects of this disclosure, the DOM may be stored remotely from the user device 106 and/or accessed/requested by the user device 106, for example, in response to a request to load a corresponding page, screen, and/or instance of a user interface and/or the like.

According to some aspects of this disclosure, asset management module 116 may use a DOM to access and manipulate the contents of iframes for a user interface. According to some aspects of this disclosure, an iframe is an HTML element that enables asset management module 116 to embed another HTML document, for example, a preview of an asset and/or the like within a current document and/or user interface. According to some aspects of this disclosure, asset management module 116 may load an iframe on a user interface to generate/create a separate DOM tree for its contents, which may be accessed and manipulated by asset management module 116 using a code library. For example, according to some aspects of this disclosure, asset management module 116 may first get a reference to an iframe element using a function/command including, but not limited to, “document.getElementById( )” and/or the like. According to some aspects of this disclosure, asset management module 116 may then use a “contentDocument” or “contentWindow” property to access the DOM of the iframe and use “innerHTML” or similar property to get the contents of the iframe.

According to some aspects of this disclosure, to generate, render, and/or cause to be displayed a preview of entity-related assets, asset management module 116 may use instances of the code library to attach iframes with HTML content to each container element in a user interface including, but not limited to, an HTML document and/or the like. For example, asset management module 116 may load the code library to be included an HTML document by including a script tag in the head of a user interface including, but not limited to, an HTML document and/or the like that points to the library's source file.

According to some aspects of this disclosure, asset management module 116 may select the container elements where the iframes associated with entity-related assets are to be attached. For example, asset management module 116 may use a function from the code library to select the container elements. Once the container elements are selected, according to some aspects, asset management module 116 may use the code library to create the iframes and attach them to the container elements. For example, asset management module 116 may call a function from the code library and pass it to the container element and the HTML content intended to be included in an iframe.

According to some aspects of this disclosure, EXAMPLE 1 below shows an example script used by asset management module 116 to generate instances of a code library to attach iframes with HTML content to each of three different container elements in an HTML document and/or user interface.

EXAMPLE 1

```
<script type=“module”>
  import HtmlAssetPreview from ‘./src/index.js';
  // First thumbnail preview. Scale size down to 20%
  // const htmlAssetPreview1 = new HtmlAssetPreview.HtmlAssetPreview({
  const htmlAssetPreview1 = new HtmlAssetPreview({
    containerElementId: ‘preview-container1’,
    assetSrc: {
      type: ‘string’,
      content: ‘<h1>Title1</h1><p>Some text1</p>’,
    },
    iframeStyle: { width: ‘400px’, height: ‘600px’, border: ‘solid darkblue’ },
  });
  HtmlAssetPreview1.scale(0.2);
  // Second thumbnail preview. Scale size down to 50%.
  // const HtmlAssetPreview2 = new HtmlAssetPreview.HtmlAssetPreview({
  const htmlAssetPreview2 = new HtmlAssetPreview({
    containerElementId: ‘preview-container2’,
    assetSrc: {
      type: ‘string’,
      content: ‘<html><head></head><body><h1>Title2</h1><p>Some
  text2</p></body>’,
    },
    iframeStyle: { width: ‘400px’, height: ‘600px’, border: ‘solid purple’ },
  });
  htmlAssetPreview2.scale(0.5);
  // Third thumbnail preview. Scale size down to 20%.
  // const htmlAssetPreview3 = new HtmlAssetPreview.HtmlAssetPreview({
  const htmlAssetPreview3 = new HtmlAssetPreview({
    containerElementId: ‘preview-container3’,
    assetSrc: {
      type: ‘string’,
      content: ‘<h1>Title3</h1><p>Some text3</p>’,
    },
    iframeStyle: { width: ‘600px’, height: ‘800px’, border: ‘solid darkgreen’ },
  });
  htmlAssetPreview3.scale(0.2);
</script>
```

According to some aspect of this disclosure, the script of EXAMPLE 1 generates three previews of assets using a code library called “HtmlAssetPreview”. The first line imports the code library HtmlAssetPreview. For each instance, the script of EXAMPLE 1 sets the following options: containerElementId, assetSrc, and iframeStyle. According to some aspects of this disclosure, the “containerElementId” option sets the identifiers of each container element where the preview will be displayed. For example, identifiers “preview-container1,” “preview-container2,” and “preview-container3” are set for each instance respectively. According to some aspects of this disclosure, the “assetSrc” option sets the source of the asset that will be displayed in the preview. As an example, the asset source is set to an object with the properties “type” and “content.” The “type” is set to ‘string’ and “content” is set to a string containing HTML. According to some aspects of this disclosure, the “iframeStyle” option sets the styling for the iframe that will display the preview of the asset. As an example, “iframeStyle” option is set to an object that sets the width, height, and border of the iframe.

According to some aspects of this disclosure, after the options are set, the script of EXAMPLE 1 calls the scale method on each instance, passing in a number that represents the scale of the preview. For example, htmlAssetPreview1.scale(0.2) is scaling the first preview to 20% of its original size.

In sum, According to some aspects of this disclosure, the script of EXAMPLE 1 uses the HtmlAssetPreview code library to create three thumbnail previews, each with different content and/or styling, and then scales the size of each preview to 20%, 50%, and 20% respectively. According to some aspects of this disclosure, EXAMPLE 1 is an example and asset management module 116 may use another coding to generate instances of a code library to attach iframes with HTML content to each container element in an HTML document and/or user interface.

According to some aspects of this disclosure, asset management module 116 may style iframes. For example, asset management module 116 may use CSS styles and/or the like to customize the appearance of the iframes. According to some aspects of this disclosure, asset management module 116 may use inline styles or link to a separate stylesheet and/or the like. According to some aspects of this disclosure, asset management module 116 may test the iframes to ensure operability. For example, asset management module 116 may generate a test of the code library function to ensure that the iframes are properly attached to the container elements and that the HTML content indicative of entity-related assets is being displayed correctly within a user interface including, but not limited to, an HTML document and/or the like.

As previously described, according to some aspects, asset management module 116 may generate, render, and/or cause to be displayed a preview page of a page of a user interface based on data/information stored by user device 106, computing device 104, an entity-managed device (e.g., an entity-managed cloud-based server, etc.), a third-party source, and/or the like. According to some aspects of this disclosure, EXAMPLE 2 below shows an example code library initialization parameters and requirements. The coding in Example 2 is annotated to indicate elements that are required (e.g., annotated with “Required”) and optional elements (e.g., annotated with “Not Required”).

EXAMPLE 2

```
{
  containerElementId: <Id of the container element> (Required),
  assetSrc: { (Required)
    type: ‘string’ (Required),
    content: <String with the markup content> (Required for type ‘string’)
  },
  contentSize: { (Not Required)
    width: <Integer or ‘autodetect’> (Required),
    height: <Integer or ‘autodetect’ (Required)>
  },
  contentSize: ‘autodetect’ (Not Required),
  loadAnimation: { (Not Required)
    type: ‘fadein’, (Required)
    duration: 1000, (in ms. Not Required, default 1000ms)
  },
  iframeStyle: { (Not Required)
    width: <Initial width of the iframe with the content> (Not required, but
  recommended if known),
    height: <Initial height of the iframe with the content> (Not required, but
  recommended if known),
    ... Further styles (Not required)
  },
  contentStyle: <string containing CSS to apply extra styling to the content> (Not
  required),
  contentSizeLimitInBytes: <Positive integer representing an amoun of Bytes> (Not
  required),
  keepContentInteractive: <boolean> (Not required),
  security: { (Not required)
    sandbox: <string> (Not required)
  },
}
```

According to some aspects of this disclosure, EXAMPLE 2 provides a collection of properties and options that are passed to an instance of the HtmlAssetPreview code library of EXAMPLE 1 when it is created. The script of EXAMPLE 2 may be used to customize the behavior and appearance of a preview of an asset.

According to some aspects of this disclosure, as shown in EXAMPLE 2, “containerElementId” is the identifier of the container element in the user interface and/or HTML page. According to some aspects of this disclosure, asset management module 116 may use the container element to attach an iframe element with the HTML content to be previewed to it. According to some aspects of this disclosure, this is done internally by the code library. As shown in EXAMPLE 2, “assetSrc” may define a type of asset. According to some aspects of this disclosure, as shown in EXAMPLE 2, “loadAnimation” causes an animation for a preview of an asset when loading it, and may define parameters such as appearance type (e.g., fade in, pixelate, slide, etc.), duration, and/or the like. As shown in EXAMPLE 2, “iframeStyle” enables CSS attributes for the iframe element to be provided.

According to some aspects of this disclosure, asset management module 116 may restrict the passing of user-provided values (e.g. some value stored in a database, etc.) to prevent CSS injection attacks and/or the like. According to some aspects of this disclosure, as shown in EXAMPLE 2, “contentStyle” enables additional styles to be added to a user interface displaying previews of assets. For example, an extra style may include, but is not limited to, “overflow: hidden,” which disables scrolling in an iframe and clipping its content. As shown in EXAMPLE 2, “contentSizeLimitInBytes” may be used to specify a size limit for HTML content and/or the like in bytes. According to some aspects of this disclosure, asset management module 116 may generate an error if the content is larger than the specified amount.

According to some aspects of this disclosure, as shown in EXAMPLE 2, “keepContentInteractive” may enable be set to dictate whether previews of assets are interactive (e.g., may be used to access the asset via an interaction with the preview, etc.). For additional security, according to some aspects of this disclosure, as shown in EXAMPLE 2, “security” is an object with attributes that allow to disable security features. According to some aspects of this disclosure, all security features may be enabled by default. Security features may include, but are not limited to, enabling downloads, limiting/preventing display interactions, enabling storage access via user activation, and/or the like. According to some aspects of this disclosure, as shown in EXAMPLE 2, the “sandbox” attribute enables a list of restrictions for the content displayed in an iframe to be specified including, but not limited to, disabling JavaScript or preventing the iframe from navigating to other origins (e.g., origins not authorized by an entity, etc.).

According to some aspects of this disclosure, EXAMPLE 2 is an example of coding library initialization parameters and requirements and other coding library initialization parameters and requirements may be implemented.

According to some aspects of this disclosure, asset management module 116 be include a predictive model (e.g., a predictive model trained using supervised and/or unsupervised methods, along with labeled and/or unlabeled data to generate previews for assets, etc.). According to some aspects of this disclosure, the predictive model may be trained, for example, with both labeled and unlabeled datasets to perform object detection via objectness, saliency detection, object localization, and/or the like on image data to identify the most important objects in an image of the image data and provide information used to generate previews of assets that focus on those objects.

According to some aspects of this disclosure, asset management module 116 may enable the code library (or one or more functions of the code library) to be exposed to third-party applications and/or modules for use. For example, a third-party application and/or module may request access to a function of the code library to generate previews of third-party assets and/or the like.

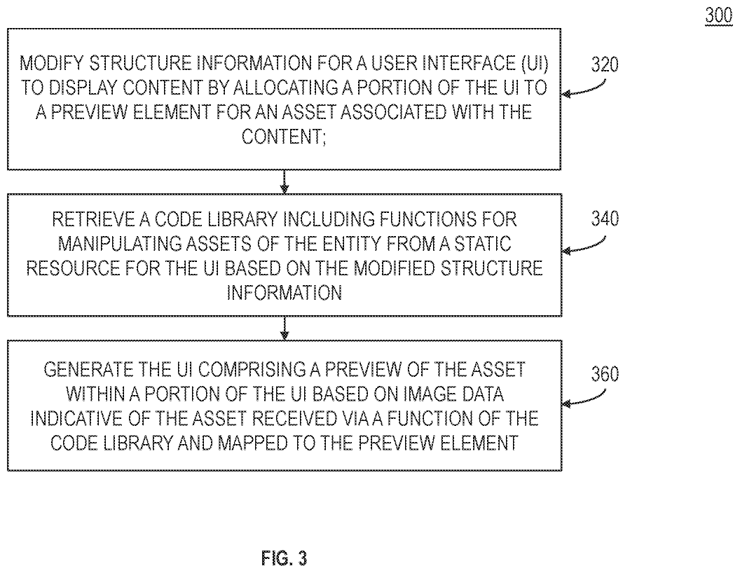

FIG. 3 shows a flowchart of an example method 300 for generating previews of entity assets, according to some aspects. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIGS. 1, 2A, and 2B. However, method 200 is not limited to the aspects of FIGS. 1, 2A, and 2B.

In 320, user device 106 modifies structure information for a user interface (UI) to display content by allocating a portion of the UI to a preview element for an asset associated with the content. According to some aspects of this disclosure, user device 106 may modify the structure information based on a request for content related to an entity. For example, according to some aspects of this disclosure, user device 106 may receive the structure information based on an identifier of an entity included with a request for content related to the entity. According to some aspects of this disclosure, the structure information may include, but is not limited to, a Document Object Model (DOM), a DOM tree, and/or the like. According to some aspects, the identifier of the entity may include, but is not limited to, an authorized token (e.g., a web token, a JavaScript web token, a simple web token (SWT) token, OAuth2 information, Passport information, Spring Security information, Auth0 information, etc.) received from a device (e.g., computing device 104, etc.) such as a server-side authentication and authorization device associated with the entity and/or the like.

According to some aspects of this disclosure, user device 106 retrieves the structure information based on information stored by and/or accessible to the user device 106. For example, user device 106 may store image data indicative of the structure information. According to some aspects of this disclosure, user device 106 may store image data indicative of the structure information based on another (e.g., previous, etc.) loading of a user interface. For example, according to some aspects of this disclosure, user device 106 (and/or a device in communication with user device 104, etc.) may capture a DOM for the user interface based on a previous/last and/or different visit/navigation to the user interface, and save it locally as a base64 image (e.g., using canvas element, JavaScript, etc.).

According to some aspects of this disclosure, user device 106 modifies the structure information based on the content. According to some aspects of this disclosure, user device 106 modifying the structure information to allocate the portion of the user interface to the preview element for the asset may include adding a first structural element of the structure information to indicate a portion of the content, removing a second structural element of the structure information based on the content, modifying a third element of the structure information to indicate another portion of the content, and/or the like. According to some aspects of this disclosure, user device 106 modifying the structure information to allocate the portion of the user interface to the preview element for the asset may include updating at least one of updating styles of a structural element of the structure information, updating an attribute of the structural element of the structure information, and/or the like.

In 340, user device 106 retrieves a code library including functions for manipulating assets of the entity. According to some aspects of this disclosure, user device 106 retrieves the code library based on the modified structure information and from a static resource for the UI.

In 360, user device 106 generates the user interface (UI) comprising a preview of the asset within a portion of the UI. According to some aspects of this disclosure, user device 106 may generate the UI based on image data indicative of the asset received via a function of the code library and mapped to the preview element. For example, according to some aspects of this disclosure, user device 106 may send, based on the function of the code library, an instruction to a predictive model to identify an object in the image data that satisfies a relevancy threshold. According to some aspects of this disclosure, the predictive model may be trained for and utilize object detection via objectness, saliency detection, object localization, and/or the like to identify the object in the image data that satisfies the relevancy threshold. According to some aspects of this disclosure, user device 106 may receive the image data indicative of the asset comprising the object from the predictive model based on the instruction.

According to some aspects of this disclosure, interaction with the preview of the asset enables access to the asset. According to some aspects of this disclosure, the preview of the asset may include, but is not limited to, an image of the asset, a video of the asset, audio content indicative of the asset, and/or the like.

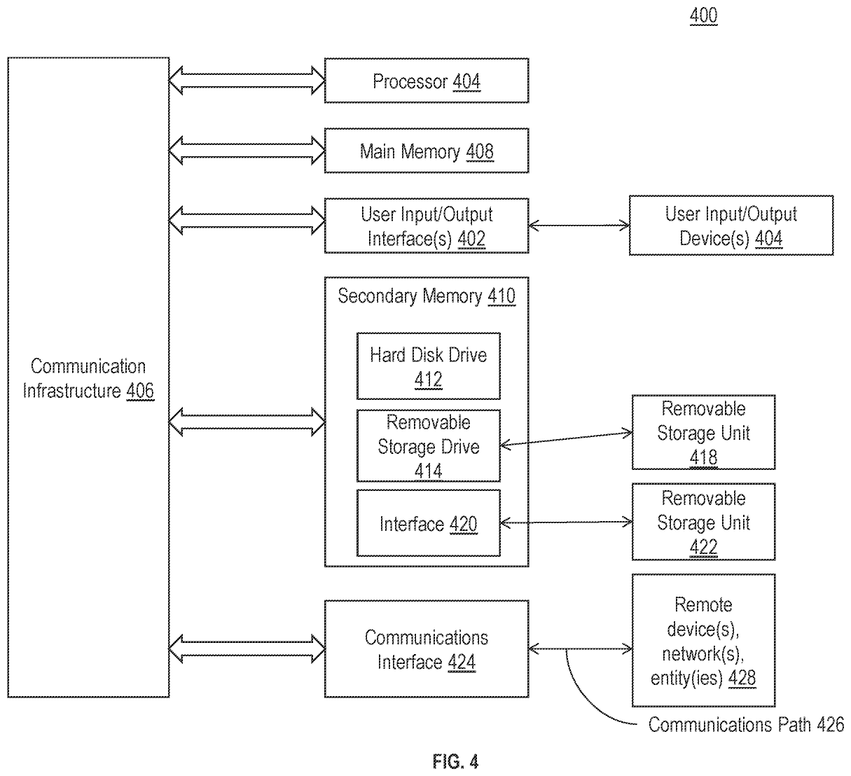

FIG. 4 is an example computer system useful for implementing various embodiments. Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof. According to some aspects of this disclosure, the user device 106 of FIG. 1 (and/or any other device/component described herein) may be implemented using the computer system 400. According to some aspects of this disclosure, the computer system 400 may be used to implement method 300 and/or any other methods and/or steps described herein.

Computer system 400 may include one or more processors (also called central processing units, or CPUs), such as a processor 404. Processor 404 may be connected to a communication infrastructure or bus 406.

Computer system 400 may also include user input/output device(s) 402, such as monitors, keyboards, pointing devices, etc., which may communicate with communication infrastructure or bus 406 through user input/output device(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, a tape backup device, and/or any other storage device/drive.

Removable storage drive 414 may interact with a removable storage unit 418. The removable storage unit 418 may include a computer-usable or readable storage device having stored thereon computer software (control logic) and/or data. Removable storage unit 418 may be a floppy disk, magnetic tape, compact disk, DVD, optical storage disk, and/or any other computer data storage device. Removable storage drive 414 may read from and/or write to the removable storage unit 418.

Secondary memory 410 may include other means, devices, components, instrumentalities, and/or other approaches for allowing computer programs and/or other instructions and/or data to be accessed by computer system 400. Such means, devices, components, instrumentalities, and/or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smartphone, smartwatch or other wearables, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats, and/or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

Additionally and/or alternatively, while this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

One or more parts of the above implementations may include software. Software is a general term whose meaning of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “an aspect,” “aspects,” “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method comprising:
modifying, by one or more computing devices and based on a request for content related to an entity, structure information for a user interface (UI) to display the content by allocating a portion of the UI to a preview element for an asset associated with the content;
retrieving, by the one or more computing devices and based on the modified structure information, a code library including functions for manipulating assets of the entity from a static resource for the UI; and
generating, based on image data indicative of the asset received via a function of the code library and mapped to the preview element, the UI comprising a preview of the asset within a portion of the UI.

2. The method of claim 1, wherein the modifying the structure information for the UI to display the content by allocating a portion of the UI to the preview element for the asset associated with the content comprises at least one of: adding a first structural element of the structure information to indicate a portion of the content, removing a second structural element of the structure information based on the content, or modifying a third element of the structure information to indicate another portion of the content.

3. The method of claim 1, wherein the modifying the structure information for the UI to display the content by allocating a portion of the UI to the preview element for the asset associated with the content comprises at least one of updating a style of a structural element of the structure information, or updating an attribute of the structural element of the structure information.

4. The method of claim 1, further comprising:
receiving from an identity management device associated with the entity, based on credential information that associates the user device with the entity sent to the identity management device, the code library; and
storing the code library as the static resource for the user interface.

5. The method of claim 1, further comprising:
sending, based on the function of the code library, to a predictive model trained for at least one of object detection via objectness, saliency detection, or object localization, an instruction to identify an object in the image data that satisfies a relevancy threshold; and
receiving based on the instruction, the image data indicative of the asset comprising the object.

6. The method of claim 1, wherein an interaction with the preview of the asset enables access to the asset.

7. The method of claim 1, wherein the preview of the asset comprises at least one of an image of the asset, a video of the asset, or audio content indicative of the asset.

8. A non-transitory computer-readable medium having instructions stored thereon that, when executed by at least one computing device, causes the at least one computing device to perform operations comprising:
modifying, based on a request for content related to an entity, structure information for a user interface (UI) to display the content by allocating a portion of the UI to a preview element for an asset associated with the content;
retrieving, by the one or more computing devices and based on the modified structure information, a code library including functions for manipulating assets of the entity from a static resource for the UI; and
generating, based on image data indicative of the asset received via a function of the code library and mapped to the preview element, the UI comprising a preview of the asset within a portion of the UI.

9. The non-transitory computer-readable medium of claim 8, wherein the modifying the structure information for the UI to display the content by allocating a portion of the UI to the preview element for the asset associated with the content comprises at least one of: adding a first structural element of the structure information to indicate a portion of the content, removing a second structural element of the structure information based on the content, or modifying a third element of the structure information to indicate another portion of the content.

10. The non-transitory computer-readable medium of claim 8, wherein the modifying the structure information for the UI to display the content by allocating a portion of the UI to the preview element for the asset associated with the content comprises at least one of updating a style of a structural element of the structure information, or updating an attribute of the structural element of the structure information.

11. The non-transitory computer-readable medium of claim 8, the operations further comprising:
receiving from an identity management device associated with the entity, based on credential information that associates a user device with the entity sent to the identity management device, the code library; and
storing the code library as the static resource for the user interface.

12. The non-transitory computer-readable medium of claim 8, the operations further comprising:
sending, based on the function of the code library, to a predictive model trained for at least one of object detection via objectness, saliency detection, or object localization, an instruction to identify an object in the image data that satisfies a relevancy threshold; and
receiving based on the instruction, the image data indicative of the asset comprising the object.

13. The non-transitory computer-readable medium of claim 8, wherein an interaction with the preview of the asset enables access to the asset.

14. The non-transitory computer-readable medium of claim 8, wherein the preview of the asset comprises at least one of an image of the asset, a video of the asset, or audio content indicative of the asset.

15. A system comprising:
a memory; and
at least one processor coupled to the memory and configured to perform operations comprising:
modifying, based on a request for content related to an entity, structure information for a user interface (UI) to display the content by allocating a portion of the UI to a preview element for an asset associated with the content;
retrieving, by the one or more computing devices and based on the modified structure information, a code library including functions for manipulating assets of the entity from a static resource for the UI; and
generating, based on image data indicative of the asset received via a function of the code library and mapped to the preview element, the UI comprising a preview of the asset within a portion of the UI.

16. The system of claim 15, wherein the modifying the structure information for the UI to display the content by allocating a portion of the UI to the preview element for the asset associated with the content comprises at least one of: adding a first structural element of the structure information to indicate a portion of the content, removing a second structural element of the structure information based on the content, or modifying a third element of the structure information to indicate another portion of the content.

17. The system of claim 15, wherein the modifying the structure information for the UI to display the content by allocating a portion of the UI to the preview element for the asset associated with the content comprises at least one of updating a style of a structural element of the structure information, or updating an attribute of the structural element of the structure information.

18. The system of claim 15, the operations further comprising:
receiving from an identity management device associated with the entity, based on credential information that associates a user device with the entity sent to the identity management device, the code library; and
storing the code library as the static resource for the user interface.

19. The system of claim 15, the operations further comprising:
sending, based on the function of the code library, to a predictive model trained for at least one of object detection via objectness, saliency detection, or object localization, an instruction to identify an object in the image data that satisfies a relevancy threshold; and
receiving based on the instruction, the image data indicative of the asset comprising the object.

20. The system of claim 15, wherein an interaction with the preview of the asset enables access to the asset.
